(19) United States
(12) Patent Application Publication
(10) Pub. No.: US 2016/0295450 A1
(43) Pub. Date: Oct. 6, 2016

(54) EXCHANGING LOAD INFORMATION IN A RADIO ACCESS NETWORK

(71) Applicant: TELEFONAKTIEBOLAGET L M ERICSSON (PUBL), Stockholm (SE)

(72) Inventors: Tomas HEDBERG, Stockholm (SE); Paul SCHLIWA-BERTLING, Ljungsbro (SE); Jari VIKBERG, Järna (SE)

(21) Appl. No.: 15/037,269

(22) PCT Filed: Nov. 19, 2013
(86) PCT No.: PCT/EP2013/074178

§ 371 Date: May 17, 2016

(51) Int. Cl. H04W 28/02; H04W 72/04; H04W 12/06; H04W 28/08

(52) U.S. Cl. CPC H04W 28/0289; H04W 28/08; H04W 72/0486; H04W 12/06; H04W 92/20

(57) ABSTRACT

A method and apparatus for exchanging load information between a first node and a co-located second node in a wireless communications access network. The first node uses a first Radio Access Technology (RAT) and the second node uses a second RAT. The first node determines the identity of the co-located second node. It then establishes a load information interface between the first node and the co-located second node. Load information can then be directly exchanged with the co-located second node using the established load information interface.

### TECHNICAL FIELD

The invention relates to exchanging load information in a Radio Access Network.

### BACKGROUND

Radio Access Networks (RANs) carry data. At busy times, a RAN may experience a high load. In order to maintain an expected Quality of Service for users of the RAN, it is necessary to ensure the network does not become too loaded. Different RANs may use different Radio Access Technologies (RATs). It is possible, when a first RAN is becoming too loaded, to perform load balancing and transfer some of the load to another RAN.

An exchange of load information is needed to perform efficient load balancing between RANs, especially when both the source (RAN) and the target (RAN) may be highly loaded. The words ‘source’ and ‘target’ are used herein to refer to the source of the load and the target to which some of the load is transferred. Load in either the source or the target may comprise, for example, radio interface load, transport network load, loads on different hardware, and may depend on hardware capabilities and other system characteristics.

When performing load balancing, prior to initiating transfer of data traffic from a source to a target, an evaluation is made of the load (and related parameters) in the source (or serving) cell, and the load (and related parameters) of any potential target cells. Potential target cells are those which can also serve a terminal such as a User Equipment (UE) that accesses a network via the source cell.

Many UEs can only access a RAN using a single type of RAT. However, an increasing number of UEs can access RANs using different RATs. Such UEs may use “Carrier Aggregation” across different RATs, in which case the traffic allocation during load balancing can be more fine-granular, i.e. only a subset of traffic for the UE is moved between the RATs. Effectively this means that only a part of the load related to a specific UE is moved between the source and target RANs.

An existing way to exchange load information between different RANs using different RATs is to piggyback load information in handover preparation signaling. Handover preparation signalling is carried through the Core Network (CN). By way of example, in the case of Packet Switched (PS) handover from a GSM EDGE Radio Access Network (GERAN) to a Universal Terrestrial Radio Access Network (UTRAN), the signaling path would be from a Base Station Controller (BSC) to a Serving GPRS Support Node (SGSN) (in the CN) to a Radio Network Controller (RNC). The protocol used between the BSC and the SGSN is typically Base Station System GPRS Protocol (BSSGP) and the protocol used between the RNC and the SGSN is typically Radio Access Network Application Part (RANAP). It is possible for the BSC and the RNC to be connected to different SGSN nodes. In this case an additional Inter-SGSN signaling step is required using the GPRS Tunneling Protocol-Control (GTP-C) protocol.

Similarly, when evolved-UTRAN (E-UTRAN) is involved in an Inter-RAT handover, then an eNodeB (eNB) communicates with a Mobility Management Entity (MME) (in the CN) using the S1AP protocol. In addition, there is an additional signaling step between the MME and the SGSN using GTP-C protocol.

An alternative way to exchange load information between different RANs using different RATs is to use the RAN Information Management (RIM) protocol. As with piggybacking load information in handover signalling, RIM messages are forwarded through the CN. The signaling steps are similar to those described above, except that RIM-specific messages are used instead of handover related messages. Many nodes are involved, which increases the overall signalling and processing load. Furthermore, where one of the RANs utilizes a Wireless Local Area Network (WLAN), there is no established method of load information exchange with cellular systems.

### SUMMARY

The signalling described above, for exchanging load information between different RANs that use different RATs, requires signals to be sent via the Core Network. As shown in FIG. 1, in order to provide load balancing between a first node 1 in a first RAN 2, and a second node 3 in second network 4, all signalling using existing mechanisms is sent via the core network 5. It would be desirable to reduce the signalling required to free up signalling and processing resources, particularly in CN nodes that currently handle such signalling. It is an object to reduce the amount of signalling required for exchanging load information between different RANs using different RATs.

According to a first aspect, there is provided a method of exchanging load information between a first node and a co-located second node in a wireless communications access network. The first node uses a first Radio Access Technology (RAT) and the second node uses a second RAT. The first node determines the identity of the co-located second node. It then establishes a load information interface between the first node and the co-located second node. Load information can then be directly exchanged with the co-located second node using the established load information interface.

An advantage of this method if that load information signalling need not by piggybacked using signalling sent via the core network, leading to a reduction in signalling and resource requirements in the core network.

As an option, after determining the identity of the co-located second node, the first node authenticates the co-located second node using security credentials.

In an optional embodiment, a load balancing operation is performed using exchanged load information. In an alternative optional embodiment, the exchanged load information is forwarded to a further controller node for performing a load balancing operation.

Examples of first node or the second node include a Base Station Controller, a Radio Network Controller, an eNodeB, an Access Controller, a Base Transceiver Station, a NodeB, and an Access Point.

The first node optionally sends information regarding a further co-located node using the established load information interface.

As an option, load information is exchanged using any of dedicated messages and/or adding new information elements to existing messages.

The identity of the co-located second node is optionally determined by either detecting the co-located second node, or receiving from a further node information identifying the co-located second node.

According to a second aspect, there is provided a node for use in a Radio Access Network using a first RAT. The node is provided with a processor for determining an identity of a co-located second node in a second Radio Access Network using a second RAT. The processor is further arranged to establish a load information interface between the node and the co-located second node. A communications arrangement is provided that is arranged to directly exchange load information with the co-located second node using the established load information interface.

As an option, the processor is further arranged to, after determining the identity of the co-located second node, authenticate the co-located second node using security credentials.

The processor is optionally further arranged to perform a load balancing operation using exchanged load information.

As an option, the node is provided with a transmitter arranged to send exchanged load information to a further controller node for performing a load balancing operation.

Examples of the node include any of a Base Station Controller, a Radio Network Controller, an eNodeB, an Access Controller, a Base Transceiver Station, a NodeB and an Access Point (12).

As an option, the communications arrangement is further arranged to send information regarding a further co-located node using the established load information interface.

The communications arrangement is optionally arranged to exchange the load information using any of dedicated messages and/or adding new information elements to existing messages.

According to a third aspect, there is provided a computer program, comprising computer readable code means which, when run from a computer readable medium in the form of a memory in a processor in a node, causes the node to perform the steps described above in the first aspect.

According to a fourth aspect, there is provided a computer program product comprising a computer readable medium and a computer program as described above in the third aspect, wherein the computer program is stored on the computer readable medium.

According to a fifth aspect, there is provided a vessel or vehicle comprising the node described above in the second aspect.

### BRIEF DESCRIPTION OF THE DRAWINGS

FIG. 1 illustrates schematically in a block diagram a known architecture showing load information signalling between nodes in different Radio Access Networks;

FIG. 2 illustrates schematically in a block diagram an exemplary information signalling between nodes in different Radio Access Networks;

FIG. 3 illustrates schematically in a block diagram exemplary co-located nodes;

FIG. 4 illustrates schematically in a block diagram further exemplary co-located nodes;

FIG. 5 is a signalling diagram showing exemplary load information signalling;

FIG. 6 is a flow diagram showing steps of an exemplary embodiment;

FIG. 7 illustrates schematically in a block diagram an exemplary network node; and

FIG. 8 illustrates schematically in a block diagram an exemplary vessel or vehicle.

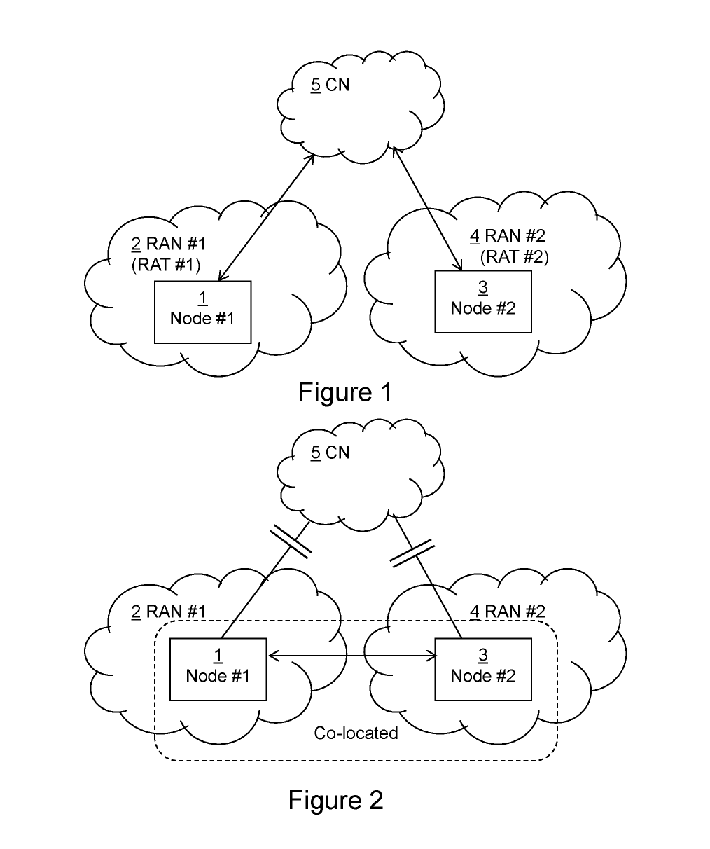

### DETAILED DESCRIPTION

It has been realised that in cases where nodes in different RANs are co-located, load information signalling can be exchanged directly between those nodes. This is illustrated in FIG. 2, which shows a first node 1 in a first Radio Access Network (RAN) 2 and a second node 3 in a second RAN 4. The two RANs may use different Radio Access Technologies (RATs). Load signalling is exchanged directly between the first node 1 and the second node 3, and so there is no need to send any of this signalling via the Core Network 5.

The term “co-located” is used herein to refer to nodes that are physically located at the same network operator site. For example, it is known to provide a Centralized Radio Access Network (CRAN) for E-UTRAN and in this case the different nodes using different RATs, such as a Base Station Controller (BSC), an eNodeB (eNB) and a Radio Network Controller (RNC) can be co-located. Note that the endpoints of the load signalling need not be co-located, but the signalling is sent via co-located nodes. For example, load signaling between an eNode B and a BSC can be sent via the Base Transceiver Station (BTS). In this case the eNodeB and BTS are co-located, and the endpoints of the load signaling are the eNode B and the BSC.

In order to exchange load information signalling, interfaces must be established between co-located nodes. In some circumstances, one or both of the co-located nodes may not be the endpoints that use the load information, but may be intermediate nodes between nodes that use the load information. The term “load information interface” is used herein to refer to an interface between two nodes that carries load information signalling even where one or both of the nodes is an intermediate node that does not require the load information.

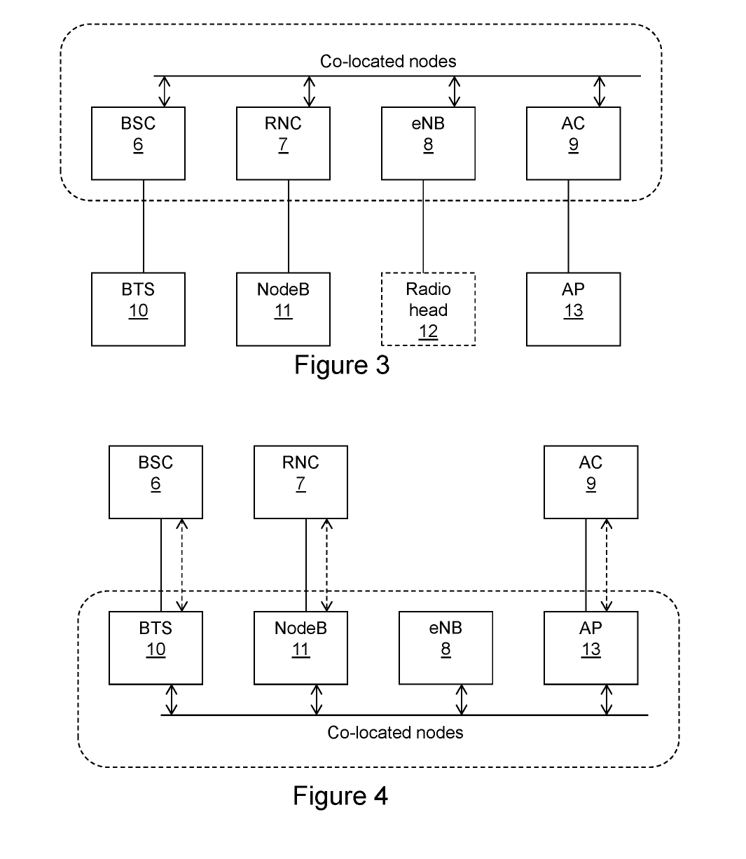

FIG. 3 illustrates a first exemplary embodiment in which a BSC 6, an RNC 7, an eNB 8 and a W-Fi access controller (AC) 9 are all co-located. Note that the co-located nodes need not include all of the nodes shown, and may include additional nodes. The nodes shown in FIG. 3 are by way of example only. The BSC 6 is in communication with a BTS 10, the RNC 7 is in communication with a NodeB 11, the eNB 8 is in communication with a radio head 12 and the Wi-Fi AC is in communication with a Wi-Fi Access Point (AC) 13.

In the example of FIG. 3, the load information signalling is sent directly between co-located BSC 6, RNC 7, eNB 8 and AC 9. As the BSC 6, RNC 7, eNB 8 and AC 9 are the RAN controlling nodes then the load information is mainly used for traffic steering decisions such as load balancing.

It should be noted that the functional split between AC and AP is, in practice, not well defined, but it will be appreciated that the techniques described herein apply to different separations of the functions of ACs 9 and APs 13.

Other arrangements of co-located nodes are possible. In the example of FIG. 4, the BTS 10, the NodeB 11, the eNB 8 and the AC 13 are co-located. While the load information may be used by any of the BSC 6, the RNC 7 and the AC 9, the signalling traverses two co-located nodes in order to avoid sending signalling via the CN 5. For example, as network load measurements must also account for the situation of BSC, RNC and transmission links, the ‘complete load’ messages are passed for example between the BSC 6 and the RNC 7, the BSC 6 and the eNB, and the RNC 7 and the eNB. In this case the BTS 10 and the NodeB 11 are co-located with the eNB and can either forward the information transparently to any of the BSC 6, the RNC 7 and the eNB 8. Alternatively, there may be circumstances where it is desirable to include additional information in the signalling that traverse the BTS 10 and/or the NodeB 11.

A further benefit of establishing interfaces for load information signalling between co-located nodes is that it bypasses the normal restrictions in RAN-level communication between different RATs. Typically, different RATs are separated in the transmission domain, for example by the usage of different Virtual LANs (VLAN). These restrictions are bypassed as the “inter-RAT” communication becomes node internal.

In the example of FIG. 4, the Abis-interface may be used between the BSC 6 and the BTS 10. The lub-interface may be used between the NodeB 11 and the RNC 7. The Control and Provisioning of Wireless Access Points (CAPWAP) protocol (or similar) may be used between the AP 13 and the AC 9. The load information exchange may be added to the existing protocol(s) used on these interfaces either as new messages or as new information elements to existing messages. The application can be based on the existing RIM-application.

In the examples of FIGS. 3 and 4, the initial detection of possible co-located nodes can be either performed via configuration or automatically. Automatic detection may be based on the different nodes sending, listening for and responding to specific multicast or broadcast detection messages in the local network. The purpose of a detection message is to ask if there are any co-located nodes. The communication may be performed e.g. either via the local LAN (for detection of co-located nodes) or via a backplane communication bus (for detection of co-located base station functionality in the same Radio Base Station (RBS)). Note that in some circumstances, possible co-located nodes may be detected by a further node, and information identifying the co-located second nodes is sent by the further node. By way of example, in the exemplary architecture of FIG. 4, the BSC 6 may detect that the eNB 8 has a co-located node, and forward this information to the BSC 6.

The first step to establish a load information interface between nodes is an initial configuration of the RAN nodes (i.e. BSC 6, BTS 10, RNC 7, NodeB 11, eNB 8, AC 9 and

AP 13) with security credentials. Security credentials are required to enable communication between different RAN nodes (for example between the RNC 7 and eNode B 8, or between the RNC 7 and the BSC 6). This prevents unauthorized usage of these interfaces. The configuration may consist for example of a “shared secret” (e.g. in form of a “pre-shared keys”) or configuration of other authentication related parameters (such as valid certificates) to enable the authentication of an RAN node attempting to establish the load information interface. The authentication is needed not only for keeping unknown intruders out, but also to avoid leakage of network-specific data between operators when some nodes are shared.

The second step is the detection of a possible neighboring co-located node with which load information can be shared. This is needed to enable the automatic detection of a candidate for establishment of the load information interface. For example, the BSC 6 may detect that an RBS with a BTS 10 connected via an Abis-interface also contains eNode B functionality for a neighboring LTE RAN cell. There are several ways this detection can be made, some examples of which are described below:

1 The detection of an IRAT (Inter-RAT) neighboring cell in a “RAN controller” via any existing RAN mechanism (e.g. based on known Automatic Neighbor Relation (ANR) methods to detect neighboring cells from other RATs). This may trigger the RAN controller (i.e. BSC 6, RNC 7 or AC 9) to query its “own base station” (i.e. BTS 10, NodeB 11 or AP 13) to check if the same RBS also contains, or is co-located with, the “other base station” controlling the detected IRAT neighboring cell. The “own base station” here means the base station that controls the cell that is the local neighbor for the detected IRAT cell. If the “other base station” is found (either co-located or contained in the same RBS) then information about this is returned to the RAN controller that triggered the query. In the LTE-case, the eNB 8 performs similar actions but these are performed locally by the eNB (i.e. the eNB can attempt to detect locally if the same RBS also contains, or is co-located with, the “other base station” controlling the detected IRAT neighboring cell).

If the other base station belongs to GSM, WCDMA or Wi-Fi/WLAN, then the information returned to the querying RAN controller also includes information identifying the other RAN controller controlling the other base station.

For example, the RNC 7 detects that LTE-cell-1 is an IRAT neighbor cell to an UTRAN-cell-1 controlled by NodeB 11 (connected to the RNC 7). The RNC 7 triggers the NodeB 11 to initiate a local query in the RBS to check if the LTE-cell-1 is controlled by an eNodeB 8 in the same RBS (or if it is co-located). Then NodeB 11 informs the RNC 7 of the results.

In another example, the RNC 7 detects that a GSM cell is a neighbor cell to a UTRAN-cell controlled by NodeB 11 (connected to the RNC 7). The RNC 7 triggers the NodeB 11 to initiate a local query in the RBS to check if the GSM-cell 1 is controlled by a BTS 10 in the same RBS (or if it is co-located) and to find out which BSC 6 controls the BTS 10. If the BTS 10 is found, then NodeB 11 informs the RNC 7 of the result (including information about the BSC 6 that controls the GSM cell 1).

An alternative way to make the detection is by detecting a neighboring Wi-Fi AP 13 via traffic steering functionality based on new interfaces from the Wi-Fi AC 9 to the RNC 7, BSC 6 and eNode B 8. The RNC 7, BSC 6 or eNode B 8 receive an indication from the Wi-Fi AC 9 about a Wi-Fi access attempt for a (potentially) 3GPP RRC connected UE with an indication of the Wi-Fi AP 13 used. In this case the BSC 6 or RNC 7 is triggered to query the base station where the UE is connected. The BSC 6 or RNC 7 is triggered to check if the same RBS also contains the Wi-Fi AP 13. In the LTE-case, the eNB 8 performs similar actions locally.

Two exemplary options for enabling the signaling between the W-Fi AC 9 and 3GPP nodes (i.e. RNC 6, BSC 7 and eNodeB 8) are as follows:

a) The current serving 3GPP RAN node (RNC 7, BSC 6, eNodeB 8) registers the UE location in a UE database function and the Wi-Fi AC 9 queries the UE database function to retrieve information about which 3GPP RAN node to contact for a specific UE. The UE identity used can in this case be the International Mobile Subscriber Identity (IMSI) as it is a common identity between 3GPP and Wi-Fi when SIM-based authentication is used on the Wi-Fi side. In the LTE-case, the MME holds information about the IMSI and registers the UE location in the UE database function. The MME can also enable the communication between the Wi-Fi AC 9 and the eNodeB 8.

b) The signaling between UE/STA (Wi-Fi station) and the Wi-Fi AP/AC (e.g. 802.11 MAC signaling) is enhanced to include an indication about the 3GPP cell that the UE/STA is currently either connected to or camping on when attempting to access a Wi-Fi access network. This indication may be, for example, the Global Cell ID of the current 3GPP cell. The Wi-Fi AC 9 may use this information to find out which 3GPP RAN node to contact. One example is to use a DNS lookup to detect an address of the 3GPP RAN node based on the Global Cell ID. A variant is to extend the information provided from the UE/STA to the Wi-Fi AP/AC with all 3GPP cells that the UE is able to detect at the point of the Wi-Fi access attempt. This would then enable the detection of multiple neighboring co-located nodes that could potentially be involved in load sharing.

The local address of a co-located node can be found using e.g. (enhanced) RIM procedures. The target address (Global Cell ID) used by RIM can be uniquely identified using a technique such as ANR. The presence of a local network ID, and possibly also local address ID on that network, can be requested/responded via RIM. If a suitable local path exists, then that interface will be established and used. This method only works currently for intra-3GPP but can be also extended to cover Another alternative for detection of the local address of a co-located node is to include this information in multicast or broadcast detection messages in the local network.

The third step is then establishment of the load information interface to the co-located node based on the detection in the second step. The RAN controller (i.e. BSC 6, RNC 7 or AC 9) triggers the establishment via its own base station indicating the target RAN node for the establishment request. The own base station relays the communication between the RAN controller and the other base station. If the other base station belongs to GSM, WCDMA or W-Fi/WLAN, then there is still an additional relaying step towards the other RAN controller controlling the cell. The initial part in the communication is authentication of the other side by both nodes. Once this is done, the load information interface is established. In the LTE-case, the eNB 8 performs similar actions but these are performed locally by the eNB 8.

The fourth and final step is then usage of the load information interface. A main purpose of the load information interface is for load information exchange that can be either periodical (e.g. every 15 seconds) or query-response based as needed. Load balancing can be performed on the basis of this information.

A further use of the load information interface is to inform each RAN node about all cells that are controlled by one side (e.g. also other cells than the detected neighbor cell that triggered the establishment of the interface). This information is useful once a neighbor cell relation is later detected as it can then be associated to an existing load information interface. Another option is to limit the communication only to include cells that are “co-located” with the other side. For example, in an interface between an “eNode B-y” and a BSC (via BTS-x that is co-located with “eNode B-y”), the information may only contain GSM cells that are controlled by BTS-x, and LTE cells that are controlled by “eNode B-y”.

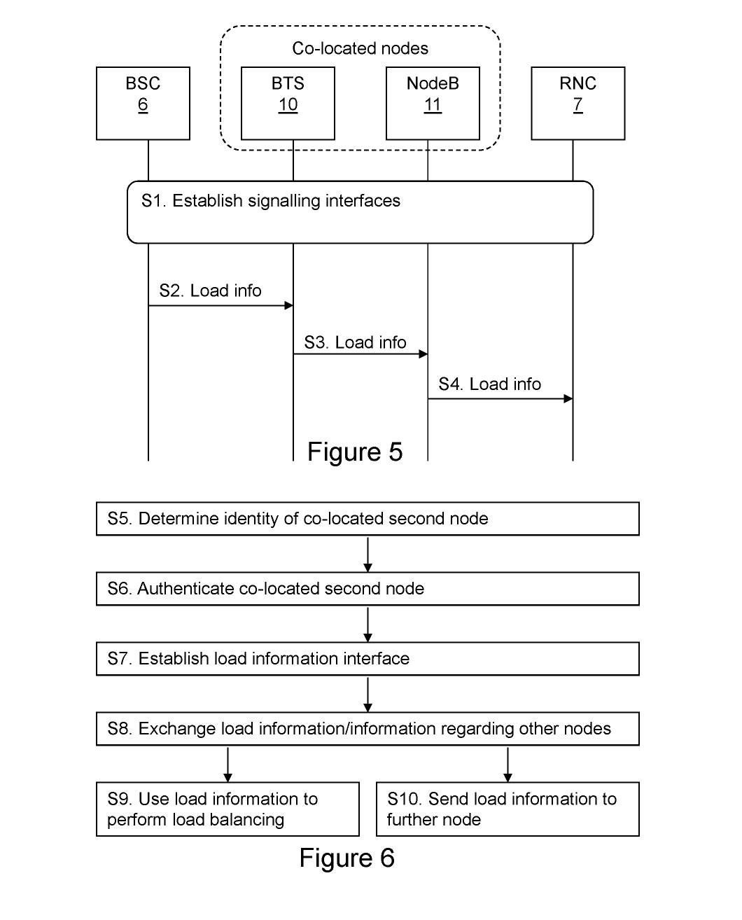

FIG. 5 shows exemplary signalling where the BTS 10 and the NodeB 11 are co-located and the load information signaling is between the BSC 6 and RNC 7. The following numbering corresponds to that of FIG. 5:

S1. A signalling interface is established between the BTS 10 and the NodeB 11, and interfaces may be established between the BTS 10 and the BSC 6, and the NodeB 11 and the RNC 7. Signalling associations may then be established between cells in the various noes, such as the BSC 6 and the RNC 7.

S2. Load information is sent via a load information interface from the BSC 6 to the BTS 10.

S3. Load information is sent via a load information interface from the BTS 10 to the co-located NodeB 11.

S4. Load information is sent via a load information interface from the NodeB 11 to the RNC 7.

FIG. 6 is a flow diagram showing exemplary steps. The following numbering corresponds to that of FIG. 6:

S5. A first node 1, such as a BSC 6, RNC 7, eNB 8 or AC 9, determines the identity of a co-located second node 3 using a detection method such as one of the methods described above, or by receiving information from a further node that identifies the co-located second node 3.

S6. In an optional embodiment, an authentication process occurs allowing the first node 1 to authenticate the second node 3.

S7. A load information interface is established between the first node 1 and the second node 3.

S8. Load information is exchanged directly using the load information interface. As described above, this may be in dedicated messages or as information elements included in other types of messages. The load information interface may also be used to send information about further nodes that may be co-located or reachable via a co-located node.

S9. In the event that the first node 1 is capable of performing a load balancing operation on the basis of the received interface, it may do so. Examples of such nodes include the BSC 6, the RNC 7, the eNB 8 and the AC 9.

S10. In the event that the first node cannot perform load balancing, or it is preferred that the first node does not perform load balancing, the load information is sent to a further node that performs load balancing. Examples of nodes that do not perform load balancing include the BTS 10, the NodeB 11 and the AP 13.

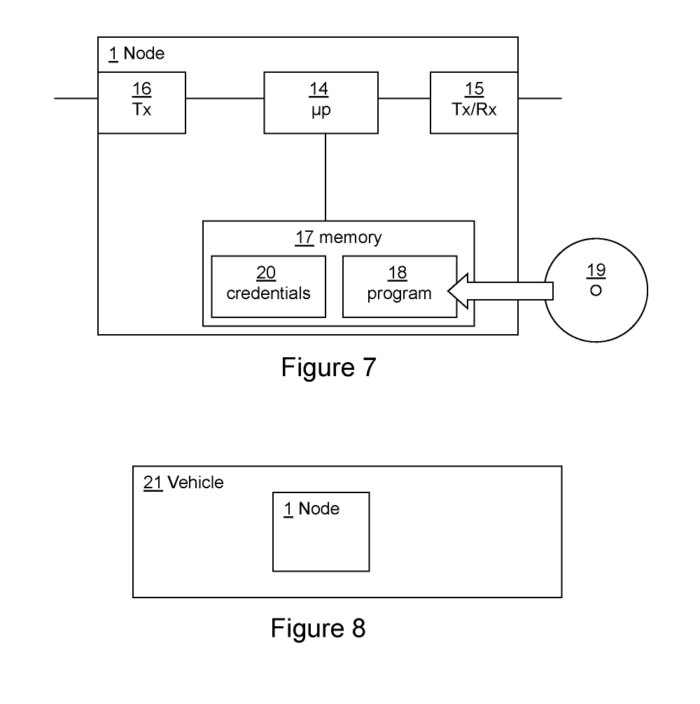

FIG. 7 illustrates schematically an exemplary node 1. The node 1 is provided with a processor 14 for performing steps such as detecting the co-located second node 2, generating signalling and so on, as described above. A communications arrangement (for example a transmitter and receiver, or transceiver) 15 is provided for sending signalling via the established load information interface (such as load information or information about other co-located nodes or nodes that can be reached via a co-located node). In an optional embodiment, the processor 14 is further arranged to perform a load balancing operation. In a further optional embodiment, a transmitter 16 is provided for sending load information to a further controller node for performing a load balancing operation.

The node 1 may also be provided with a non-transitory computer readable medium in the form of a memory 17. The memory 17 may be used for storing a computer program 18 which, when executed by the processor 14, causes the node 1 to behave as described above. Note that the program may be obtained from a remote source 19, such as a data carrier. The memory 17 may also be used to store further information, such as security credentials 20 usable to authenticate the node.

FIG. 8 illustrates a vessel or vehicle 21 such as a car, a truck, an aeroplane, a train, a ship and so on. The vessel or vehicle 21 is provided with the node 1 described above and illustrated in FIG. 7.

The techniques described above provide more efficient signalling of load information, since fewer nodes, especially Core Network nodes, are involved. Furthermore, network deployments sometimes use separate transport networks for different radio technologies. This can be motivated by factors such as security, lower risk of errors or re-use of IP addresses. Using co-located nodes as “bridges” solves these issues.

It will be appreciated by the person of skill in the art that various modifications may be made to the above described embodiments without departing from the scope of the present invention as defined in the appended claims.

The following abbreviations have been used in this description:

AC Access Controller

ANR Automatic Neighbor Relation

AP Access Point

BSC Base Station Controller

BSSGP Base Station System GPRS Protocol

BTS Base Transceiver Station

CAPWAP Control and Provisioning of Wireless Access Points

CN Core Network

CRAN Centralized Radio Access Network

eNB eNodeB

E-UTRAN evolved-UTRAN

GERAN GSM EDGE Radio Access Network

GPRS General Packet Radio Service

GSM Global System for Communications

GTP-C GPRS Tunneling Protocol-Control

IMSI International Mobile Subscriber Identity

IRAT Inter-RAT

NodeB Node B

PS Packet Switched

RAN Radio Access Network

RANAP Radio Access Network Application Part

RAT Radio Access Technologies

RBS Radio Base Station

RIM RAN Information Management

RNC Radio Network Controller

SGSN Serving GPRS Support Node

STA Station

UE User Equipment

UTRAN Universal Terrestrial Radio Access Network

WLAN Wireless Local Area Network

1. A method of exchanging load information between a first node and a co-located second node in a wireless communications access network, the first node using a first Radio Access Technology, RAT, the second node using a second RAT, the method comprising, at the first node:
determining an identity of the co-located second node;
establishing a load information interface between the first node and the co-located second node; and
directly exchanging load information with the co-located second node using the established load information interface.

2. The method according to claim 1, further comprising after determining the identity of the co-located second node, authenticating the co-located second node using security credentials.

3. The method according to claim 1, further comprising performing a load balancing operation using exchanged load information.

4. The method according to claim 1, further comprising forwarding exchanged load information to a further controller node for performing a load balancing operation.

5. The method according to claim 1, wherein any of the first node and the second node is selected from any of a Base Station Controller, a Radio Network Controller, an eNodeB, an Access Controller, a Base Transceiver Station, a NodeB and an Access Point.

6. The method according to claim 1, further comprising sending information regarding a further co-located node using the established load information interface.

7. The method according to claim 1, further comprising exchanging the load information using any of dedicated messages and/or adding new information elements to existing messages.

8. The method according to claim 1, wherein determining the identity of the co-located second node comprises any of detecting the co-located second node and receiving from a further node information identifying the co-located second node.

9. A node for use in a Radio Access Network using a first RAT, the node comprising:
a processor for determining an identity of a co-located second node in a second Radio Access Network using a second RAT
the processor being further arranged to establishing a load information interface between the node and the co-located second node; and
a communications arrangement arranged to directly exchange load information with the co-located second node using the established load information interface.

10. The node according to claim 9, wherein the processor is further arranged to, after determining the identity of the co-located second node, authenticate the co-located second node using security credentials.

11. The node according to claim 9, wherein the processor is further arranged to perform a load balancing operation using exchanged load information.

12. The node according to claim 9, further comprising a transmitter arranged to send exchanged load information to a further controller node for performing a load balancing operation.

13. The node according to claim 9, wherein the node is selected from any of a Base Station Controller, a Radio Network Controller, an eNodeB, an Access Controller, a Base Transceiver Station, a NodeB and an Access Point.

14. The node according to claim 9, wherein the communications arrangement is further arranged to send information regarding a further co-located node using the established load information interface.

15. The node according to claim 9, wherein the communications arrangement is arranged to exchange the load information using any of dedicated messages and/or adding new information elements to existing messages.

16. A non-transitory computer readable medium comprising computer readable code which, when run in a processor in a node, causes the node to perform the method of claim 1.

17. (canceled)

18. A vessel or vehicle comprising the node according to claim 9.
